(19) United States
(12) Patent Application Publication
(10) Pub. No.: US 2007/0063650 A1
(43) Pub. Date: Mar. 22, 2007

(54) PLASMA DISPLAY DEVICE AND METHOD FOR MANUFACTURING THE SAME

(75) Inventors: Dae Hyun PARK, Yongin-si, Gyeonggi-do (KR); Kyung Ku KIM, Anyang-si, Gyeonggi-do (KR); Byung Hwa SEO, Seoul (KR); Min Soo PARK, Seoul (KR); Won Seok JEON, Suwon-si, Gyeonggi-do (KR); Dong Oh SHIN, Gwacheon-si, Gyeonggi-do (KR); Deok Hai PARK, Joong-gu, Daegu (KR); Hong Cheol LEE, Seoul (KR); Je Seok KIM, Anyang-si, Gyeonggi-do (KR); Byung Gil RYU, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/470,290

(22) Filed: Sep. 6, 2006

(30) Foreign Application Priority Data
Sep. 6, 2005 (KR) 10-2005-0082619

(51) Int. Cl. H01J 17/49; H01J 61/40; H01J 5/16

(52) U.S. Cl. 313/582; 313/587; 313/110; 313/112

(57) ABSTRACT

A plasma display panel having an enhanced brightness and a method for manufacturing the same are disclosed. The plasma display panel includes a first substrate including barrier ribs, a second substrate arranged to face the first substrate, such that the second substrate defines a plurality of discharge cells, together with the first substrate, and lens structures formed between the first substrate and the second substrate, to condense light generated from the discharge cells such that the condensed light is outwardly emitted.

This application claims the benefit of Korean Patent Application No. 10-2005-0082619, filed on Sep. 6, 2005, which is hereby incorporated by reference as if fully set forth herein.

### BACKGROUND OF THE INVENTION

1. Field of the Invention

The present invention relates to a plasma display panel, and more particularly, to a plasma display panel having an enhanced brightness and a method for manufacturing the same.

2. Discussion of the Related Art

Plasma display panels are well known as an emissive device which displays an image using a discharge phenomenon. Such a plasma display panel is being highlighted as a display for an image display device having a large screen because the plasma display panel has many advantages of simple manufacture, large screen size, and rapid response speed in that it is unnecessary to provide active elements for respective cells.

Referring to FIG. 1, a structure of such plasma display panel (PDP) is illustrated. As shown in FIG. 1, the PDP has a structure in which an upper panel 10 and a lower panel 20 are overlapped with each other such that they face each other. For each cell, the upper panel 10 includes a pair of sustain electrodes arranged on an inner surface of a transparent substrate 11. Typically, the sustain electrodes include a transparent electrode 12 and a bus electrode 13.

Such sustain electrodes are coated with a dielectric layer 14 for an AC driving operation. A protective film 15 is formed over the dielectric layer 14.

On the other hand, the lower panel 20 includes address electrodes 22 arranged on an inner surface of the lower panel 20 over a dielectric layer 21. An insulating layer 23 is formed over the address electrodes 22. Barrier ribs 24 are formed on the insulating layer 23, to define discharge cell spaces. Red, blue, and green phosphor layers 26 are coated on the barrier ribs 24 in grooves each formed between the adjacent barrier ribs 24, to form sub-pixels, respectively.

Discharge cells 25 are defined by the barrier ribs 24 for respective sub-pixels. Discharge gas is sealed in each discharge cell 25. The above-mentioned three different sub-pixels constitute one pixel.

Light generated in each discharge cell 25 of the PDP having the above-mentioned structure excites the associated phosphor layer 26, thereby causing the phosphor layer 26 to generate light of the associated color. The light generated from the phosphor layer 26 is then emitted through the transparent substrate 11 of the upper panel 10.

However, the emission of the light is carried out in various directions. Furthermore, the light emitted toward regions other than the transparent dielectric layer 14 and transparent electrodes 12 cannot emerge from the transparent substrate 11 due to the bus electrodes or a black matrix film 16 formed between the adjacent electrodes. For this reason, there may be brightness loss in the PDP.

Typically, the dielectric layer 14 of the upper panel 10 is formed by forming a dielectric material in the form of a film using a green sheet or screen printing process, and then baking the formed film.

In some cases, a stepped dielectric structure having grooves or otherwise formed to have unevenness is used, in order to achieve a reduction in discharge voltage and an enhancement in brightness.

### SUMMARY OF THE INVENTION

Accordingly, the present invention is directed to a plasma display panel and a method for manufacturing the same that substantially obviate one or more problems due to limitations and disadvantages of the related art.

An object of the present invention is to provide a plasma display panel which includes a lens structure provided at each discharge cell, to cause light emitted from phosphors to be condensed while passing through the lens structure, thereby maximizing the brightness of the panel, and a method for manufacturing the plasma display panel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel comprises: a first substrate including barrier ribs; a second substrate arranged to face the first substrate, such that the second substrate defines a plurality of discharge cells, together with the first substrate; and lens structures formed between the first substrate and the second substrate, to condense light generated from the discharge cells.

The lens structures may be formed using a dielectric layer arranged between the first substrate and the second substrate.

The lens structures may have a radius of curvature corresponding to 224 to 7,800 μm.

Each of the lens structures focuses the light generated from an associated one of the discharge cells on a point arranged outside the panel between display electrodes of the associated discharge cell.

The lens structures may have a concave lens shape such that each lens structure is thicker at a position toward each barrier rib associated with the lens structure, and is thinner at a position toward a central portion of an associated one of the discharge cells.

The lens structures may have cross-sections each having a longitudinal concave lens shape, respectively, and extend longitudinally in parallel. The lens structures may have thick portions having a rod shape and extending in parallel, respectively.

The rod-shaped portions of the lens structures may extend in a direction corresponding to an extension direction of sustain electrodes (transparent electrodes) of the discharge cells.

The lens structures may have a circular lens shape, and may be regularly arranged to correspond to the discharge cells, respectively.

In another aspect of the present invention, a plasma display panel comprises: lens structures respectively arranged in spaces of discharge cells of the plasma display panel.

The lens structures may be formed on a dielectric layer of an upper substrate included in the plasma display panel.

In another aspect of the present invention, a method for manufacturing a plasma display panel comprises: forming a dielectric layer on a substrate such that the dielectric layer covers electrodes on the substrate; pressing the dielectric layer such that lens structures are formed on the dielectric layer; and baking the dielectric layer.

The step of forming the lens structures may comprise pressing, against the dielectric layer, a plate including pressing portions having a lens shape corresponding to a shape of the lens structures.

The step of forming the lens structures may comprise pressing, against the dielectric layer, a cylindrical roller including pressing portions having a lens shape corresponding to a shape of the lens structures.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating a general plasma display panel;

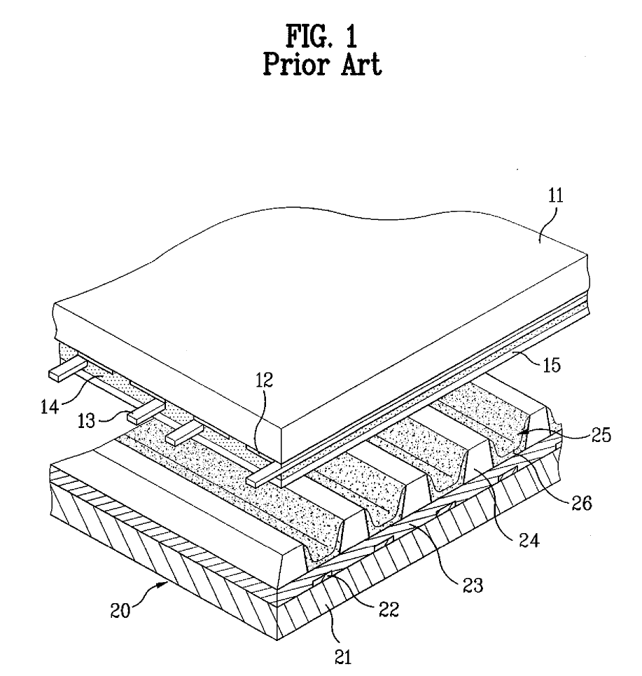

FIG. 2 is a schematic view illustrating emission of light from a conventional plasma display panel;

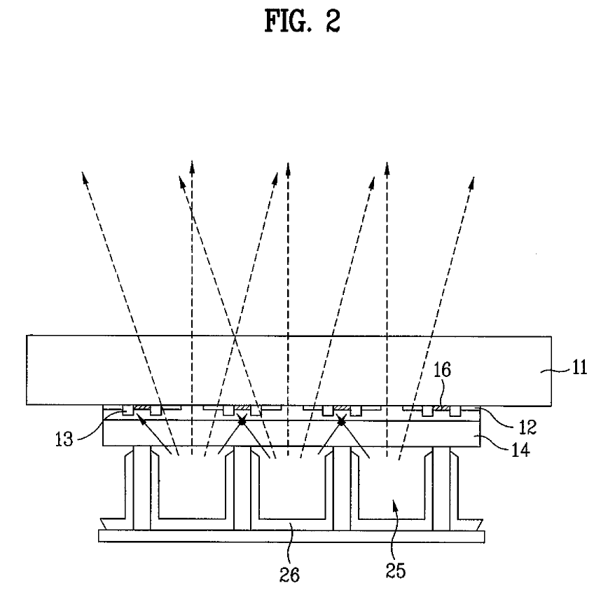

FIG. 3 is a schematic view illustrating emission of light from a plasma display panel according to present invention;

FIG. 4 is a perspective view illustrating an embodiment of lens structures included in the plasma display panel according to the present invention;

FIG. 5 is a perspective view illustrating another embodiment of lens structures included in the plasma display panel according to the present invention;

FIGS. 6 and 7 are schematic views illustrating a method for forming the lens structures of the plasma display panel in accordance with an embodiment of the present invention; and

FIGS. 8 and 9 are schematic views illustrating a method for forming the lens structures of the plasma display panel in accordance with another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

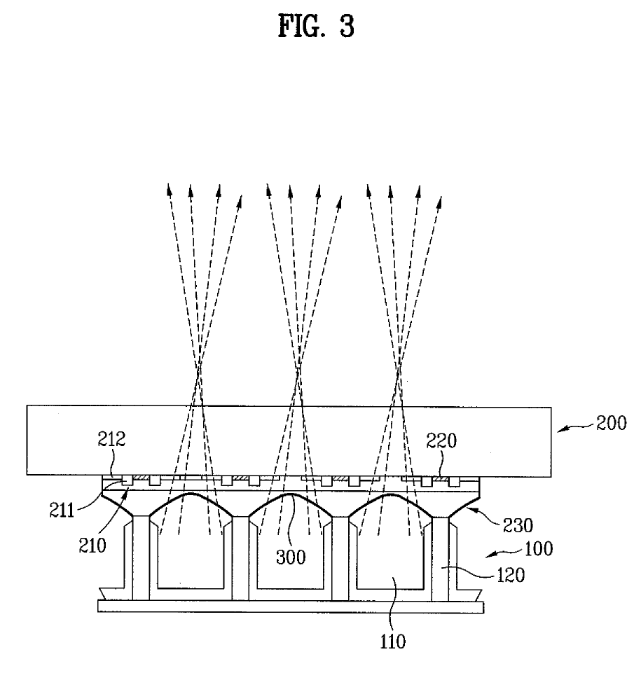

Referring to FIG. 3, a plasma display panel (PDP) according to an exemplary embodiment of the present invention is illustrated. As shown in FIG. 3, the PDP includes a first substrate 100. Discharge cells 100 are defined on the first substrate 100 by a plurality of barrier ribs 120 formed on the first substrate 100. A phosphor layer 130 may be formed on an inner surface of each discharge cell 110.

The PDP also includes a second substrate 200 provided with electrodes 210. The electrodes 210 may include bus electrodes 211 and transparent electrodes 212.

The first substrate 100 may constitute a lower panel of the PDP, whereas the second substrate 200 may constitute an upper panel of the PDP.

In some cases, a black matrix film 220 may be provided between the electrodes 210 of each discharge cell 110.

As shown in FIG. 3, lens structures 300 may be arranged between the first substrate 100 defined with the multiple discharge cells 110 and the second substrate 200 provided with the electrodes 210 for generation of light in the discharge cells 110.

In detail, the lens structures 300 are arranged in respective discharge cells 110.

Thus, light generated in each discharge cell 110 is outwardly emitted after being condensed by an associated one of the lens structures 300.

That is, the light generated in the discharge cell 110 is focused on the transparent electrodes 212 of the discharge cell 110 or on a region where the remaining electrodes 210 of the discharge cell 110, namely, the bus electrodes 211, are not arranged, without being emitted toward the bus electrodes 211 or the black matrix 220 arranged between the adjacent bus electrodes 211.

Accordingly, the light generated in each discharge cell 110 can be outwardly emitted through the first substrate 100 without being lost.

Meanwhile, it is desirable that each lens structure 300 be formed on a dielectric layer 230 laminated on the first substrate 100.

The dielectric layer 230 is made of a transparent dielectric material. Accordingly, the dielectric layer 230 can have a function to reflect light, like a lens.

In this connection, the lens structures 300 function to condense light. In this regard, the lens structures 300 have a concave lens shape such that each lens structure 300 is thicker at a portion thereof toward each associated barrier rib 120.

The lens structures 300 may have a convex lens shape, depending on the material of the lens structures 300.

Hereinafter, various examples of the lens structures 300 will be described in detail.

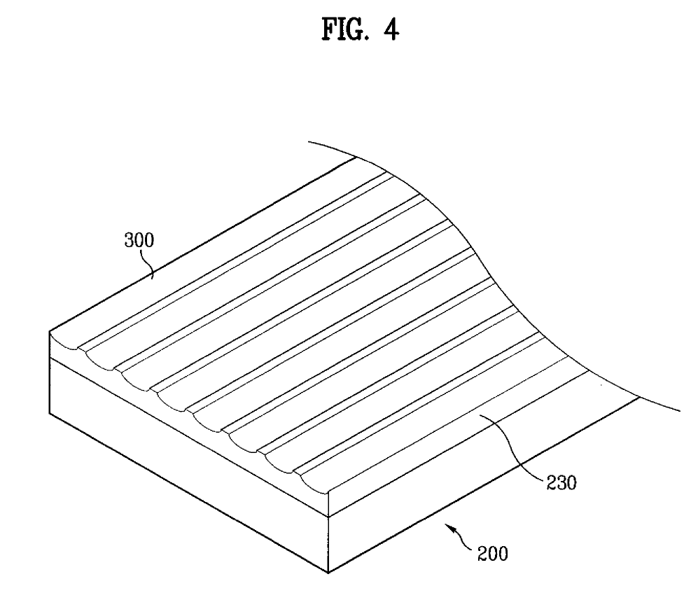

In an example illustrated in FIG. 4, the lens structures 300 have cross-sections each having a longitudinal concave lens shape, respectively, and extend longitudinally in parallel. The extension direction of the lens structures 300, in detail, the concave lens shapes, corresponds to the extension direction of the electrodes 210.

That is, in the example of FIG. 4, the PDP may include lens structures 300 having a longitudinal lens shape. In this case, the peripheral portion of each lens structure 300 may be arranged along the associated barrier ribs 120.

The lens structures 300, which have concave lens shapes extending in parallel, as described above, may be more advantageous when they are applied to the case in which the barrier ribs 120 are of a stripe type. Of course, the lens structures 300 of FIG. 4 may also be used in the case in which the barrier ribs 120 are of a well type.

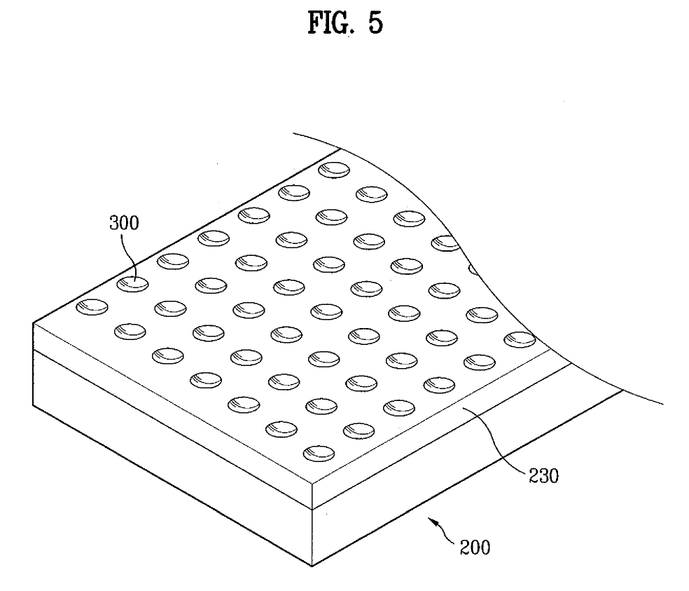

Another example is illustrated in FIG. 5. In the example of FIG. 5, the lens structures 300 have a circular lens shape, and are regularly arranged in longitudinal and lateral directions.

In this case, the lens structures 300 may be regularly arranged such that they correspond to respective discharge cells 100.

Taking into consideration the height and width of each discharge cell 110, it is preferred that each lens structure 300 have a radius of curvature corresponding to 224 to 7,800 μm.

For the lens shape of FIG. 5, any of the concave and concave lens shapes may be used.

The lens structures 300 having the lens shape of FIG. 5 may be more advantageous when they are applied to the case in which the barrier ribs 120 are of the well type. Of course, the lens structures 300 of FIG. 5 may also be used in the case in which the barrier ribs 120 are of the stripe type.

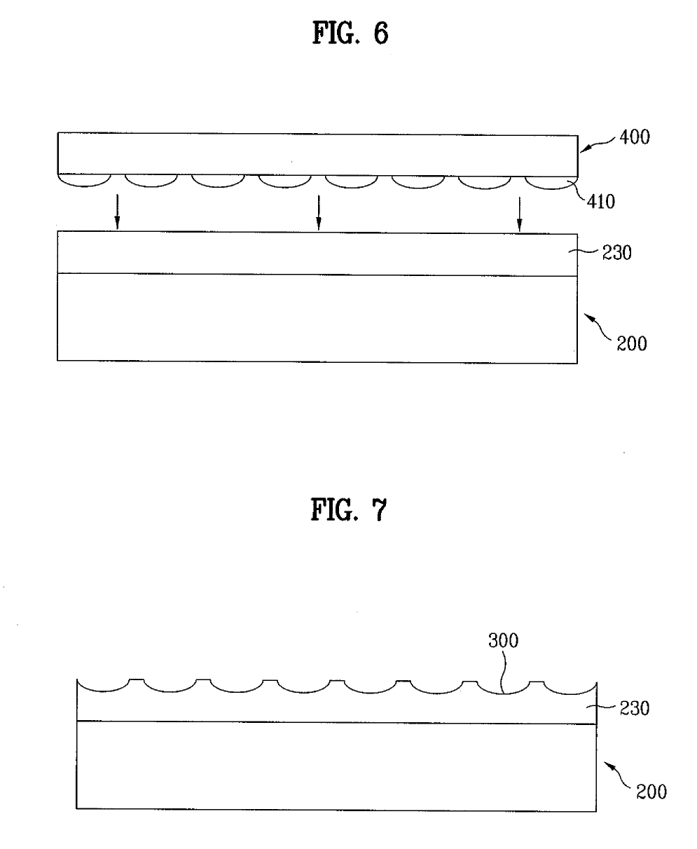

Now, a method for manufacturing the PDP having the above-described lens structures 300 will be described with reference to FIGS. 6 to 9.

The above-described lens structures 300 may be formed using a pressing method, as shown in FIGS. 6 and 7. This pressing method will be described hereinafter.

First, the dielectric layer 230 is formed by coating a dielectric paste on the upper panel 200 of the PDP such that the dielectric paste covers the electrodes 210. Alternatively, the dielectric layer 230 may be formed using a dielectric green sheet.

Thereafter, the lens structures 300 are formed by pressing a pressing die against the dielectric layer 230. The pressing die includes pressing portions corresponding to respective lens structures 300 and having a shape identical to the shape of the lens structures 300.

For the pressing die, a plate 400 having regularly-arranged convex lens shapes 410, as shown in FIG. 6, may be used.

In some cases, the plate 400 may have concave lens shapes.

The plate 400 is then pressed against the surface of the coated dielectric layer 230, to form the lens structures 300, as shown in FIG. 7.

The above-described method may be used in forming both the lens structures 300 of FIGS. 4 and 5.

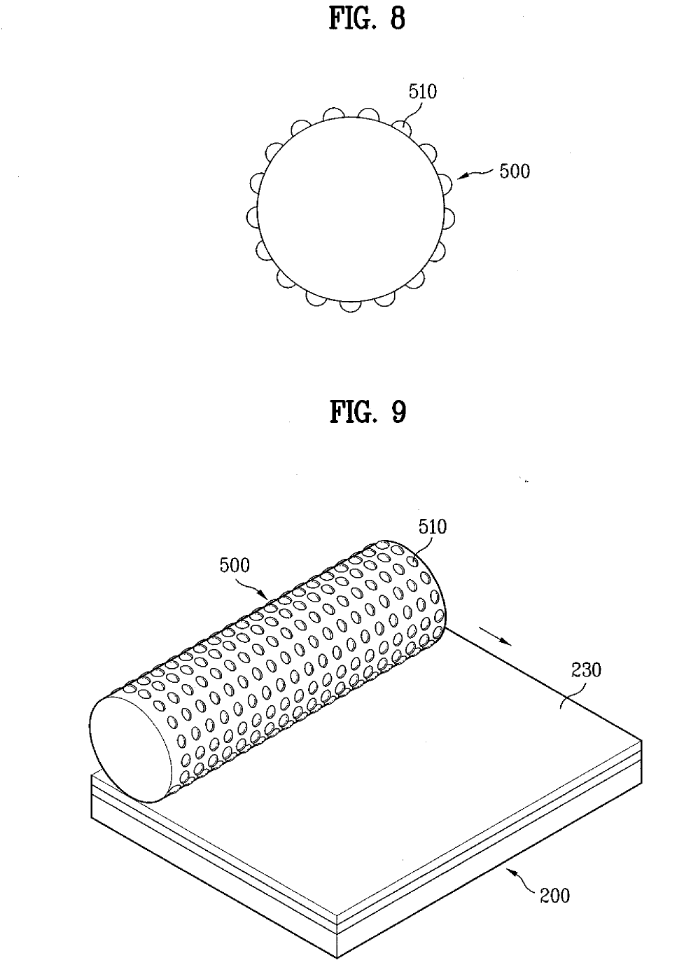

Another example of the pressing die for forming the lens structures 300 is illustrated in FIG. 8. Referring to FIG. 8, a cylindrical roller 500 is used which has convex lens shapes 510 regularly arranged on the surface of the cylindrical roller 500.

Alternatively, concave lens shapes may be formed on the surface of the cylindrical roller 500.

Where the cylindrical roller 500 having the lens shapes 510 is used, it is possible to form the lens structures 300 by pressing the cylindrical roller 500 against the surface of the dielectric layer 230 while rolling the cylindrical roller 500 along the surface of the dielectric layer 230, as shown in FIG. 9.

This method may also be used in forming the shapes of the lens structures 300 shown in FIG. 5.

If the cylindrical roller 500 has pressing portions extending longitudinally in parallel, it is possible to form the lens structures 300 of FIG. 4, using this cylindrical roller.

After the formation of the lens structures 300 on the dielectric layer 230 as described above, the upper panel 200 formed with the lens structures 300 is baked, to cause the lens structures 300 to be hardened.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising:
a first substrate including barrier ribs;
a second substrate arranged to face the first substrate, such that the second substrate defines a plurality of discharge cells, together with the first substrate; and
lens structures formed between the first substrate and the second substrate, to condense light generated from the discharge cells.

2. The plasma display panel according to claim 1, wherein the lens structures are formed using a dielectric layer arranged between the first substrate and the second substrate.

3. The plasma display panel according to claim 2, wherein the dielectric layer is formed on the second substrate, and the lens structures are formed on the dielectric layer.

4. The plasma display panel according to claim 1, wherein the lens structures have a radius of curvature corresponding to 224 to 7,800 μm.

5. The plasma display panel according to claim 1, wherein each of the lens structures focuses the light generated from an associated one of the discharge cells on a point arranged outside the panel between display electrodes of the associated discharge cell.

6. The plasma display panel according to claim 1, wherein the lens structures have a concave lens shape such that each lens structure is thicker at a position toward each barrier rib associated with the lens structure, and is thinner at a position toward a central portion of an associated one of the discharge cells.

7. The plasma display panel according to claim 1, wherein:
the lens structures have cross-sections each having a longitudinal concave lens shape, respectively, and extend longitudinally in parallel;
the lens structures have thick portions having a rod shape and extending in parallel, respectively.

8. The plasma display panel according to claim 7, wherein the rod-shaped portions of the lens structures extend in a direction corresponding to an extension direction of transparent electrodes of the discharge cells.

9. The plasma display panel according to claim 1, wherein the lens structures have a circular lens shape, and are regularly arranged.

10. The plasma display panel according to claim 9, wherein the lens structures are regularly arranged to correspond to the discharge cells, respectively.

11. A plasma display panel comprising:
lens structures respectively arranged in spaces of discharge cells of the plasma display panel.

12. The plasma display panel according to claim 11, wherein the lens structures are formed on a dielectric layer of an upper substrate included in the plasma display panel.

13. The plasma display panel according to claim 11, wherein the lens structures have a radius of curvature corresponding to 224 to 7,800 μm.

14. The plasma display panel according to claim 11, wherein the lens structures condense light generated from the discharge cells.

15. The plasma display panel according to claim 11, wherein each of the lens structures has a concave lens shape arranged at an associated one of the discharge cells.

16. The plasma display panel according to claim 11, wherein the lens structures have cross-sections each having a longitudinal concave lens shape, respectively, and extend longitudinally in parallel.

17. The plasma display panel according to claim 11, wherein the lens structures have circular lens shapes regularly arranged at the discharge cells, respectively.

18. A method for manufacturing a plasma display panel, comprising:
forming a dielectric layer on a substrate such that the dielectric layer covers electrodes on the substrate;
pressing the dielectric layer such that lens structures are formed on the dielectric layer; and
baking the dielectric layer.

19. The method according to claim 18, wherein the step of forming the lens structures comprises pressing, against the dielectric layer, a plate including pressing portions having a lens shape corresponding to a shape of the lens structures.

20. The method according to claim 18, wherein the step of forming the lens structures comprises pressing, against the dielectric layer, a cylindrical roller including pressing portions having a lens shape corresponding to a shape of the lens structures.
